(19) United States
(12) Patent Application Publication
(10) Pub. No.: US 2017/0245493 A1
(43) Pub. Date: Aug. 31, 2017

(54) NON-WOVEN FABRIC CONTAINING MICROENCAPSULATED ESSENTIAL OILS FOR PRESERVATION OF CROPS

(71) Applicant: BOTANOCAP LTD., Ganei Tikva (IL)

(72) Inventors: Yigal GEZUNDHAIT, Ganey Tikva (IL); Avishay PELAH, Kiryat-Ono (IL)

(73) Assignee: BOTANOCAP LTD., Ganei Tikva (IL)

(21) Appl. No.: 15/514,189

(22) PCT Filed: Sep. 21, 2015
(86) PCT No.: PCT/IL2015/050955

§ 371 Date: Mar. 24, 2017

Related U.S. Application Data
(60) Provisional application No. 62/056,623, filed on Sep. 29, 2014.

(51) Int. Cl. A01N 25/28; A01N 65/08; A01N 25/34

(52) U.S. Cl. CPC A01N 25/28; A01N 25/34; A01N 65/08

(57) ABSTRACT

Provided is an insect-repellant, fungicidal, fungistatic, bactericidal, bacteriostatic, and/or spoilage retardant composite material for preservation of crops including post-harvest crops, the material including a non-woven fabric and a microencapsulated essential oil embedded in the non-woven fabric; wherein the water content of the material is less than 10%; and wherein the material exerts an insect-repellant, a fungicidal, a fungistatic, a bactericidal, a bacteriostatic and/or a spoilage retardant effect on the crop.

### FIELD OF THE INVENTION

The present invention provides non-woven fabrics having embedded therein or associated therewith microencapsulated essential oils, the fabrics useful for preservation of crops including preservation of post-harvest crops.

### BACKGROUND OF THE INVENTION

Essential oils have been known for many years to have different desired properties, such as antiseptic, disinfectant, antifungal, antibacterial etc. Consequently, essential oils have been used as natural products for a number of uses. Over the years, they have been replaced with less expensive but effective synthetic chemical agents, but given the toxicity and environmental effects of these synthetic chemicals, there is a rising interest in using once more the natural essential oil agents. This objective necessitates the development of formulations that combine the desired properties of the natural essential oils while matching the efficacy of synthetic agents, at a low cost.

WO 2004/098767 discloses a process for the preparation of essential oil microcapsules by encapsulation of an essential oil through interfacial polymerization, whereby a polyurea and/or polyurethane film is formed around the liquid essential oil droplets. These microcapsules may be used as disinfectant products for the consumer market as hard-surface cleaners, laundry detergents and softeners, as pesticides, insect repellents, and as antiviral or antifungal agents.

WO 2006/007756 discloses agricultural formulations of essential oil microcapsules and uses thereof, which were also prepared by interfacial polymerization, and comprise a combination of a volatile essential oil and a non-volatile carrier. The microcapsules were a liquid core of essential oil optionally with additives and other active agents such as insect growth regulators (IGRs).

U.S. Pat. No. 8,753,676 discloses a new method for the preparation of microencapsulated essential oils is disclosed. The microcapsules containing essential oils or a formulation containing thereof may be used for various non-agricultural applications.

Incorporating active ingredients into fabric materials is known in the art, for example in wet-wipes and in so-called scratch-and-sniff stickers.

EP 0393289 discloses a water-insoluble liquid microencapsulated particulate in dry powder form substantially non-adhered to a carrier substrate. The method of making the product comprises preparing a slurry by contacting the encapsulated particulates with a suspending agent and with a wetting agent and applying the slurry to the carrier substrate, and evaporating the wetting agent from the applied slurry, thereby preparing the microencapsulated liquid product.

WO 2007/036710 discloses a microencapsulated insecticide-treated fabric and a method for treating the fabric with a composition comprising at least one microencapsulated insecticide and at least one polymeric binder. The coated or partially coated fabric maintains a sufficient amount of microencapsulated insecticide on the fabric surface to kill or repel insects, particularly mosquitoes, even after repeated washings. The fabric can be made into a net, clothing, and the like, for protection against insect-transmitted diseases such as malaria.

There remains a need for environmentally non-harmful and low-cost means for treating crops, such as post-harvest crops to inhibit their decay during transport and storage.

### SUMMARY OF THE INVENTION

The present invention provides non-woven fabrics having associated therewith, embedded therein or attached thereto microcapsules containing essential oils. Advantageously, the essential oils are released from the microcapsules over a predetermined period of time thereby providing insecticidal, fungicidal, fungistatic, spoilage retardant properties or other desired activities in the vicinity of the fabric from which the essential oils are released. The present invention thus provides compositions, referred to herein as materials composite materials or articles, comprising the fabric in conjunction with microencapsulated essential oils.

Aspects of the present invention relate to insect-repellant, fungicidal, fungistatic, bactericidal, bacteriostatic, spoilage retardant and other active agents incorporated into fabrics for preservation of crops, including post-harvest crops. The fabric is a non-woven fabric having associated therewith a microencapsulated essential oil and/or having an essential oil encapsulated thereon. The concentration of the encapsulated essential oil within the fabric is in the range of 0.1 gr of encapsulated essential oil/m² to 20 gr of encapsulated essential/m² of fabric.

Transport and storage of post-harvest crops is a well-known challenge. Decay of crops prior to reaching the consumer is common and expenses involved in preventing the decay (for example transportation in coolers) as well as losses due to wastage are considerable. A common solution is treating the crops with synthetic chemical agents. However, such agents often cause harm to human health and environment.

Thus, the present invention provides non-harmful and low-cost means for treating crops to inhibit their decay during transport and storage. The fabric associated with the microencapsulated essential oil, disclosed herein, is suitable for preservation of crops, including post-harvest crops.

Advantageously, the microcapsules have a controlled release profile from the fabric, which ensures prolonged duration of the essential oil as an insect repellant, a bacteriocidal, a bacteriostatic, a fungicidal, a fungistatic and/or a spoilage retardant agent. Furthermore, the essential oil can be released from the fabric at a broad range of temperatures including the low temperatures of cooled environments, as well as the high temperatures of tropic climates. Advantageously, an optimal release profile is achieved when the fabric is placed in room temperature or even higher making the fabric particularly suitable for transport and storage of crops originating in countries or regions having a hot climate and may obviate the need of cooling during transport. Furthermore, due to the advantageous release profile of the encapsulated essential oil from the fabric, only small amounts of essential oils are required. In effect, the essential oil containing fabric, disclosed herein, provides a cost-effective solution to post-harvest transport and storage of crops.

Importantly, the fabric, containing the encapsulated essential oil, is dry which is imperative for avoiding decay of the crop. Being dry, the fabric may be wrapped around the crop, or placed in the crop-containers thus avoiding the need for spraying a formulation directly on the crop. In addition, the materials of the fabric as well as the microcapsules are non-toxic and generally recognized as safe (GRAS) and environmentally friendly, thereby reducing toxicity and detrimental environmental effects.

According to some embodiments, there is provided a composite material for preservation of a crops, including post-harvest crops, the material comprising a non-woven fabric in non-covalent association with an encapsulated essential oil, the essential oil having activity selected from insect-repellant, fungicidal, fungistatic, bactericidal, bacteriostatic and/or spoilage retardant effect; the encapsulated essential oil embedded in or adhering to the non-woven fabric; wherein the water content of the composite material is less than 10%. According to some embodiments, the concentration of the encapsulated essential oil within the fabric is in the range of 0.01 gr of encapsulated essential oil/m² to 10 gr of encapsulated essential/m² of fabric; and wherein said non-woven fabric exerts an insect-repellant, a fungicidal, a fungistatic, a bactericidal, a bacteriostatic and/or a spoilage retardant effect on the crops.

According to some embodiments, the material exerts the insect-repellant, the fungicidal, the fungistatic, the bactericidal, the bacteriostatic and/or the spoilage retardant effect for a period of days, weeks or months after initiation of use of the microencapsulated essential oil in association with the non-woven fabric. According to some particular embodiments, the material exerts the insect-repellant, the fungicidal, the fungistatic, the bactericidal, the bacteriostatic and/or the spoilage retardant effect for at least two weeks after initiation of use of the encapsulated essential oil in association with the non-woven fabric. According to some embodiments, the material is stored in an enclosed package that prevents evaporation or release of the encapsulated essential oil or oils prior to the unsealing of the package.

According to some embodiments, the concentration of the encapsulated essential oil within the fabric is in the range of 0.05 gr of encapsulated essential oil/m² to 10 gr of encapsulated essential/m² of fabric. According to some embodiments, the concentration of the encapsulated essential oil within the fabric is in the range of 0.05 gr of encapsulated essential oil/m² to 1 gr of encapsulated essential/m² of fabric.

According to some embodiments, the material is suitable for preservation of a crops stored at a temperature in the range of 4-35° C. According to some embodiments, the material is suitable for preservation of a crops stored at a temperature in the range of 15-35° C.

According to some embodiments, the material is dry, having a water content of less than 10 weight percent. According to some embodiments, the material has a water content of less than 5 weight percent. According to some embodiments, the material has a water content of less than 3 weight percent. According to some embodiments, the material has a water content of less than 1 weight percent.

According to some embodiments, the encapsulated essential oil is microencapsulated. According to some embodiments, the microcapsule is associated with the non-woven fabric by immersion of the non-woven fabric within a suspension comprising the microencapsulated essential oil. According to some embodiments, the microcapsule is associated with the non-woven fabric by spraying the microencapsulated essential oil onto the non-woven fabric. According to some embodiments, the microcapsule comprises a polyurea, a polyurethane or an amphiphatic shell.

According to some embodiments, the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill oil, eucalyptus oil, fennel oil, garlic oil, geranium oil, ginger oil, grapefruit oil, guaiacwood oil, hiba oil, ho camphor oil, iris oil, Japanese mint oil, jasmine oil, lavender oil, laurel leaf oil, lemon oil, lemongrass oil, lime oil, linaloe oil, lindera oil, mandarin oil, mustard oil, neroli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, meric oil, vetivert oil, western mint oil, white micromeria oil, wintergreen oil, combinations and/or derivatives thereof.

According to specific embodiments, the essential oil comprises oregano oil. According to specific embodiments, the essential oil comprises mustard oil. According to some embodiments, the essential oil comprises citronella oil.

According to some embodiments, the derivative is selected from the group consisting of allyl isothiocyanate, alpha-terpineol, amyl cinnamic aldehyde, anisic aldehyde, benzyl alcohol, benzyl acetate, cinnamaldehyde, cinnamic alcohol, carvacrol, carveol, carvone, citral, citronellal, citronellol, eucalyptol (cineole), eugenol, iso-eugenol, galaxolide, geraniol, guaiacol, hexanal, ionone, d-limonene, menthol, methyl anthranilate, methyl ionone, methyl salicylate, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin, and any combination thereof.

According to some embodiments, the material further comprises a non-volatile oil. According to some embodiments, the non-volatile oil is selected from the group consisting of: cottonseed oil, neem oil, castor oil, pyrethrum oil, sesame oil, combinations and/or derivatives thereof.

According to some embodiments, the non-volatile oil is non-encapsulated. According to some embodiments, the non-volatile oil is co-encapsulated with the essential oil. According to some embodiments, the non-volatile oil is encapsulated separate from the essential oil.

According to some embodiments, the material further comprises a natural preservative. According to alternative embodiments, the encapsulated essential oil itself acts as a preservative.

According to some embodiments, the material is devoid of synthetic preservatives. According to some embodiments, the material is devoid of binders. According to some embodiments, the material is devoid of surfactants. According to some embodiments, the material is devoid of synthetic active ingredients.

According to some embodiments, the material is reusable. According to some embodiments, the material is biodegradable.

According to some embodiments, the microencapsulated material further comprises an outer coating layer. According to some embodiments, the coating layer is a wax.

According to some embodiment, there is provided a composite material for inhibiting browning of crop, the material comprising a non-woven fabric in non-covalent association with encapsulated mustard oil, the mustard oil having an anti-browning effect on the crop; wherein the water content of the material is less than 10%. According to some embodiments, the concentration of the encapsulated mustard oil within the fabric is in the range of 0.1 gr of encapsulated mustard oil/m² to 20 gr of encapsulated mustard oil/m² of fabric, in the range of 0.05 gr of encapsulated mustard oil/m² to 10 gr of encapsulated mustard oil/m² of fabric or in the range of 0.01 gr of encapsulated mustard oil/m² to 1 gr of encapsulated mustard oil/m² of fabric.

According to some embodiments, the material is dry, having a water content of less than 10 weight percent. According to some embodiments, the material has a water content of less than 5 weight percent. According to some embodiments, the material has a water content of less than 3 weight percent. According to some embodiments, the material has a water content of less than 1 weight percent.

According to some embodiments, there is provided a method for inhibiting browning of a crop, the method comprising exposing the crop to a non-woven fabric associated with microencapsulated mustard oil, thereby inhibiting the enzymatic browning of the crop.

According to some embodiments, the crop is susceptible to browning due to presence of polyphenol oxidase. According to some embodiments, the crop is lettuce.

According to some embodiments, exposing the crop to the composite material comprising the non-woven fabric associated with the microencapsulated mustard oil comprises storing the crop in containers containing therein the composite material.

Further embodiments, features, advantages and the full scope of applicability of the present invention will become apparent from the detailed description and drawings given hereinafter. However, it should be understood that the detailed description, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 shows an exemplary release profile of carvone from the microcapsules disclosed herein.

FIG. 2 shows representative pictures of grapes stored for one week in containers coated with a non-woven fabric containing microencapsulated tea tree oil (left) or in containers devoid of fabric (right).

FIG. 3 shows representative pictures of lettuce stored for two weeks in plastic containers with a non-woven fabric containing microencapsulated mustard oil (left) or in containers devoid of fabric (right).

FIG. 4 shows the percentage of peppers having molds on their stems (black columns) and the percentage of rotten peppers (white columns) observed for peppers stored for 20 days in plastic bags together with a non-woven fabric containing microencapsulated oregano oil (treated) and for peppers stored in plastic bags devoid of fabric (control).

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. Additionally, it is to be explicitly understood that any combination of any one or more of the disclosed embodiments may be applicable and is within the scope of the disclosure.

There is provided according to some embodiments, a composite material for preservation of crops, the material comprising a non-woven fabric comprising an encapsulated essential oil associated with the non-woven fabric. According to some embodiments, the material may be for treatment of soil and/or agricultural fields.

According to some embodiments, the material may have an insect-repellant, insecticidal, fungicidal, fungistatic, nematicidal, herbicidal, bactericidal, bacteriostatic, spoilage retardant properties or combination of properties. Each possibility is a separate embodiment.

As used herein the term “essential oil” refers to concentrated hydrophobic liquids containing aroma compounds of plants. An oil is essential in the sense that it contains the characteristic fragrance of the plant that it is taken from. Essential oils are volatile that evaporate at room temperature.

Non-limiting examples of suitable essential oils include angelica oil, anise oil, basil oil, bay oil, bergamot oil, bois de rose oil, calendula oil, cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill oil, eucalyptus oil, fennel oil, garlic oil, geranium oil, ginger oil, grapefruit oil, guaiacwood oil, hiba oil, camphor oil, iris oil, Japanese mint oil, jasmine oil, lavender oil, laurel leaf oil, lemon oil, lemongrass oil, lime oil, linaloe oil, lindera oil, mandarin oil, mustard oil, neroli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, meric oil, vetivert oil, western mint oil, white micromeria oil, wintergreen oil or any combination thereof. Each possibility is a separate embodiment.

According to a specific embodiment, the essential oil is oregano oil. According to a specific embodiment, the essential oil is mustard oil. According to a specific embodiment, the essential oil is tea tree oil.

As used herein, the term “non-woven fabric” refers to materials made from long fibers, bonded together by chemical, mechanical, heat or solvent treatment, and are neither woven nor knitted. Typically, the fabric is a flat or tufted porous sheet made directly from separate fibers, molten plastic or plastic film. According to some embodiments, the non-woven fabrics may at least partially be made from recycled fabrics and/or oil-derived polymeric materials. According to some embodiments, the recycled fabric may be fabric shredded, granulated and formed into small pellets, which are subsequently polymerized, melted and spun into new filament fiber used to make new fabrics. According to some embodiments, the non-woven fabrics may be recycled after use. According to some embodiments, the fabric is reusable. It is understood that reuse of the fabric may require re-embedding microencapsulated essential oils within the fabric. According to some embodiments, the fabric is biodegradable. According to some embodiments, the non-woven fabric is a polypropylene non-woven fabric. According to some embodiments, the non-woven fabric comprises cotton, rayon, wool, polyamide, polyolefin, polyester or any combination thereof. Each possibility is separate embodiment.

According to some embodiments, the microcapsules may be absorbed on and/or adhered to and maintained on the surfaces of the fabric to which they are applied.

According to alternative embodiments, the encapsulated essential oil is encapsulated on the fabric thereby forming a polymeric envelope around the essential oil and the fabric. According to some embodiments, the encapsulated essential oil is associated with the non-woven fabric by encapsulation of the essential oil on the non-woven fabric.

According to some embodiments, the encapsulated essential oil may be microencapsulated. As used herein the term “microencapsulated” refer to microcapsules having a shell and core structure, namely a solid shell surrounding a core comprising temporarily entrapped substances such as essential oils. According to some embodiments, the term “microcapsule” refers to microcapsules having an average size of 0.05-250 microns, 0.1-150 microns, 1-100 microns, 10-100 microns, 20-100 microns or any other range within 0.05-250 microns. Each possibility is a separate embodiment.

According to some embodiments, the microcapsule comprises 10-20, 20-30, 30-40, 40-50, 50-60, 60-70, 70-80, 80-90, 90-95 or any other suitable range within the range of 10-95 percent per weight essential oil. Each possibility is a separate embodiment. Preferably, the microcapsules comprises above 20 percent per weight essential oil. The remainder of the microcapsules may be comprised of the encapsulating shells and additives.

According to some embodiments, the encapsulating shell comprises polyurea, polyurethane, a multivalent salt form of an alkanoic acid or any other suitable polymer. According to some embodiments, the capsules retard evaporation or prevent oxidation of the encapsulated essential oil. According to some embodiments, the capsules have sustained release properties. As used herein, the term “sustained release” refers to a release of the essential oil at a predetermined rate in order to maintain a constant essential oil concentration for a specific period of time. For example, the essential oil may be released at a rate providing an initial daily release of 15%, 10%, 5%, 1%, 0.5%, 0.1% or 0.05% of the encapsulated essential oil from the microcapsule. Each possibility is a separate embodiment. According to some embodiments, the release rate may be temperature and/or humidity dependent providing higher release rates at elevated temperatures (e.g. above 25° C.) and humidity (e.g. above 40%).

According to some embodiments, the fabric may include two or more encapsulated essential oils, such as two, three, four or more encapsulated essential oils. Each possibility is a separate embodiment. According to some embodiments, the two or more encapsulated essential oils may be co-encapsulated. According to alternative embodiments, the two or more encapsulated essential oils may be separately encapsulated.

According to some embodiments, the encapsulated active ingredient is a derivative of an essential oil. It is understood, that the essential oil derivative may be used as an alternative to or in addition to the encapsulated essential oil itself. It is further understood that the essential oil derivative may be encapsulated together with an essential oil different from the essential oil from which it is derived.

Non-limiting examples of essential oil derivatives include allyl isothiocyanate, alpha-terpineol, amyl cinnamic aldehyde, anisic aldehyde, benzyl alcohol, benzyl acetate, cinnamaldehyde, cinnamic alcohol, carvacrol, carveol, carvone, citral, citronellal, citronellol, eucalyptol (cineole), eugenol, iso-eugenol, galaxolide, geraniol, guaiacol, hexanal, ionone, d-limonene, menthol, methyl anthranilate, methyl ionone, methyl salicylate, alpha-phellandrene, perillaldehyde, phenyl ethyl alcohol, 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin or any combination thereof. Each possibility is a separate embodiment. According to some embodiments, the essential oil derivative may be a synthetic derivative. Each possibility is a separate embodiment.

According to some embodiments, the fabric may further include a non-volatile oil. According to some embodiments, the non-volatile oil may be co-encapsulated with the essential oil. According to some embodiments, the non-volatile oil may be encapsulated separately from the essential oil. According to some embodiments, the non-volatile oil may be non-encapsulated.

As used herein the term “non-volatile oil” refers to non-volatile oils extracted from plants. Non-volatile oils have lower vapor pressures than volatile oils at the same temperature and thus do not evaporate at room temperature (typically referring to ambient temperatures in the range of 20-30° C.). Non-limiting examples of non-volatile oils include cottonseed oil, sesame oil, neem oil, castor oil, pyrethrum oil or combinations thereof. Each possibility is a separate embodiment.

As used herein the term “post-harvest” refers to the stage of crop production immediately following harvest including storage and transport of the crop.

As used herein, the term “preservation” with regards to a crop, refers to extending the amount of time passing between harvest of the crop to initiation of its decay. It is thus understood that, preservation of the crop extends its shelf-life, i.e. the length of time that it may be stored without becoming unfit for use or consumption.

As used herein the term “crop” refers to any cultivar that is harvested for food, clothing, livestock fodder, biofuel, medicine, or other uses. Each possibility is a separate embodiment. According to some embodiments, the crop is edible. Non-limiting examples of edible crops suitable for the treatment with the fabric include grapes, lettuce, peppers, cherries, strawberries, onions, herbs, apples, pears, melons, avocado, citrus fruit etc.

According to some embodiments, the fabric is suitable for use during cultivation of pre-harvest crop. Additionally or alternatively, the fabric is suitable for use during storage of post-harvest crop. According to some embodiments, the fabric is suitable for treatment of soil, fields, bushes, trees and the like, for example by spreading the fabric over the desired area. According to some embodiments, exposing the crop to the fabric containing the microcapsules extends the shelf life of the crop by at least 10%, 20%, 30%, 40%, 50%, 60%, 70%, 100%, 200%, 300% or more. Each possibility is a separate embodiment.

According to some embodiments, the fabric may be contained within a package or sealed envelope preventing evaporation of the essential oil prior to opening thereof. According to some embodiments, the fabric may be vacuum packed prior to use.

According to some embodiments, the concentration of the encapsulated essential oil within the fabric is in the range of 0.01-50 gr of encapsulated essential oil/m², 0.1-40 gr of encapsulated essential oil/m², 0.25-30 gr of encapsulated essential oil/m²; in the range of 0.5-25 gr of encapsulated essential oil/m² in the range of 1-20 gr of encapsulated essential oil/m², in the range of 1-10 gr of encapsulated essential oil/m², in the range of 0.1-10 gr of encapsulated essential oil/m², in the range of 0.1-1 gr of encapsulated essential oil/m² or any other suitable range within the range of 0.01-50 gr of encapsulated essential oil/m². Each possibility is a separate embodiment. It is understood that the concentration of the essential oil within the fabric can be determined by various methods. For example, the essential oil may be extracted from the fabric by placing the fabric in methanol and ultrasonicating to rupture the microcapsules adhered to the fabric and releasing the essential oil into the methanol. Essential oil content can then be determining using conventional HPLC or Gas Chromatography GC methods.

According to some embodiments, the non-woven fabric associated with the encapsulated essential oil exerts an insect-repellant, a fungicidal, a fungistatic, a bactericidal, a bacteriostatic and/or a spoilage retardant effect on the crop. Each possibility is a separate embodiment. According to some embodiments, the insect-repellant, the fungicidal, the fungistatic, the bactericidal, the bacteriostatic and/or the spoilage retardant effect of the encapsulated essential oil containing non-woven fabric lasts for at least 1 week, at least two weeks, at least one month, at least two months, at least 6 months, or at least 1 year after association of the encapsulated essential oil to the non-woven fabric and/or after opening and/or unsealing a package containing the fabric. Each possibility is a separate embodiment.

According to some embodiments, the non-woven fabric associated with the encapsulated essential oil may be used for treatment of a crops, soils or agricultural fields. Each possibility is a separate embodiment. According to some embodiments, the non-woven fabric associated with the encapsulated essential oil may exert an insect-repellant, an insecticidal, a nematicidal, a herbicidal, a fungicidal, a fungistatic, a bactericidal, a bacteriostatic and/or a spoilage retardant effect on the crops, soils and/or fields when placed in proximity thereto. Each possibility is a separate embodiment.

According to some embodiments, the encapsulated essential oil containing non-woven fabric has an optimal efficacy when placed on or in proximity to crops at a temperature in the range of 10° C.-45° C., 15° C.-35° C., 20° C.-30° C. or any other suitable temperature above 4° C. and/or below 50° C., such as any range within 10° C.-45° C. Each possibility is a separate embodiment.

According to some embodiments, the encapsulated essential oil containing non-woven fabric is essentially devoid of water. According to various embodiments, the encapsulated essential oil containing non-woven fabric has a water content of less than 20 percentage by weight of the fabric, less than 10 percentage by weight of the fabric, less than 5 percentage by weight of the fabric, less than 4 percentage by weight of the fabric, less than 3 percentage by weight of the fabric, less than 2 percentage by weight of the fabric, less than 1 percentage by weight of the fabric, less than 0.5 percentage by weight of the fabric. Each possibility is a separate embodiment.

According to some embodiments, the fabric may be devoid of surfactants and/or co-surfactants.

According to some embodiments, the encapsulated essential oil may be associated with the non-woven fabric. According to some embodiments, the term “associated with” may refer to non-covalently adhering essential oil containing microcapsules to the non-woven fabric, non-covalently embedding essential oil containing microcapsules within the fibers of the non-woven fabric or any other way attachment of the microcapsules to the non-woven fabric. According to some embodiments, the essential oil may be encapsulated on and/or within the non-woven fabric, thereby forming an encapsulating envelope around the essential oil and/or the fabric. Non-limiting techniques for encapsulating the oil on the fabric include 1) dipping the fabric in oil and then coating the oil soaked fabric with a polymeric or waxy material; 2) dipping the fabric in a solution or a mixture of oil and a melted polymer or wax, which then dries on the fabric; 3) as in option 2, but the solution is made out of a solvent that dissolves the polymer or wax and the oil; once the solvent evaporates the fabric is coated with a polymer or wax containing the oil. 4) electrospinning a solution or mixture of oil and a polymer from which the fabric will be made.

According to some embodiments, the fabric is devoid of binders such as, but not limited to, ethyl vinyl acetate copolymer.

Non-limiting examples of methods of associating the microencapsulated essential oil in the fabric include immersing the non-woven fabric in a suspension comprising the encapsulated essential oil, spraying the encapsulated essential oil onto the non-woven fabric or any other suitable method of adhering the microcapsules to the fabric. Each possibility is a separate embodiment. Alternatively, the essential oil may be encapsulated directly on the fabric, thereby forming an encapsulating envelope around the essential oil and the fabric, without initial microencapsulation of the essential oil, as essentially described above.

According to some embodiments, the microcapsule may include at least one outer coating, such as but not limited to, a wax, a fatty acid, a polysaccharide or low-melting polymer. Each possibility is a separate embodiment. It is understood, that the outer encapsulating layer may slow the release rate of the encapsulated essential oil from the microcapsule. It is further understood that the microcapsule may be coated by more than one coating layer, such as for example 2, 3, 4 or more coating layers. Each possibility is a separate embodiment. It is further understood that the coating layers may be same (e.g. two layers of bee wax) or different (e.g. one layer of bee wax and another layer of paraffin).

Additionally or alternatively, the encapsulated essential oil containing non-woven fabric may include an outer layer such as but not limited to a wax layer, a fatty acid layer or a low-melting polymer layer. It is understood, that the outer layer may slow the evaporation of the essential oil from the fabric. It is further understood that the fabric may be coated by more than one coating layer, such as for example 2, 3, 4 or more coating layers. Each possibility is a separate embodiment. It is further understood that the coating layers may be same (e.g. two layers of bee wax) or different (e.g. one layer of bee wax and another layer of paraffin).

As used herein the term “wax” refers to chemical compounds that are malleable near ambient temperatures. Non-limiting examples of suitable waxes include bee wax, paraffin, lanolin carnauba wax, candelilla wax, ouricury wax and combinations thereof. Each possibility is a separate embodiment.

According to some embodiments, the encapsulated essential oil containing non-woven fabric may be self-preserved. As used herein the term “self-preserved fabric” refers to a fabric containing an essential oil, which may serve as a preservative in addition to or as an alternative to its insect-repellant, fungicidal, fungistatic, bactericidal, bacteriostatic and/or spoilage retardant property. An example of an essential oil which may serve as a preservative includes, but is not limited to, rosemary oil, neem oil, caraway oil, cinnamon oil, clove oil, cumin oil, eucalyptus oil, lavender oil, lemon oil, lemongrass oil, mustard oil, rose oil, sage oil, sandalwood oil, thyme oil or combinations thereof. Each possibility is a separate embodiment. According to some embodiments, the encapsulated essential oil containing non-woven fabric may include a natural preservative, which is not an essential oil, such as castor oil, honey, bee propolis, lecithin, grapefruit seed extract, or combinations thereof. Each possibility is a separate embodiment. According to some embodiments, the natural preservative (whether an essential oil or not) may be co-encapsulated with the essential oil, be separately encapsulated or be non-encapsulated. Each possibility is a separate embodiment. According to some embodiments, the encapsulated or encapsulated essential oil containing non-woven fabrics may be devoid of synthetic preservatives.

According to some embodiment, the fabric, the encapsulated material and/or the microcapsules associated therewith may include an anti-oxidant.

According to advantageous embodiments, the product is devoid of synthetic active ingredients. According to alternative embodiments, the essential oil may be co-encapsulated with an additional active agent, which is not an essential oil. Non-limiting examples of additional agents include insect repellants, fungicides, fungistatics, bactericides, bacteriostatic and/or spoilage retardant agents or combinations thereof. Each possibility is a separate embodiment. Additionally or alternatively, the additional active agent may be an insecticide, a pesticide, a nematicide, a herbicide, spoilage retardant or combinations thereof. Each possibility is a separate embodiment. Additionally or alternatively, the additional agent may be separately encapsulated or non-encapsulated. It is thus understood that the non-woven fabric disclosed herein may have associated therewith encapsulated volatile essential oils and additional agents which may be co-encapsulated with the volatile essential oil, separately encapsulated or non-encapsulated.

Non-limiting examples of suitable agents include carbamates, triazines, triazole, uracil derivative, organophosphate, dinitroaniline, acylalanines, pyrethroids, organochlorines, carbofuran, azinphos-methyl, sulfentrazone, carfentrazone-ethyl, cypermethrin, cyromazine, beta-cyfluthrin, endosulfan, phosmet, chlorobromuron, chloroxuron, chlorotoluron, fluometuron, metobromuron, nefocide, thiazafluron, teflubenzuron, hexaflumuron, diflubenzuron, flufenoxuron, lufenuron, chlorfluazuron, dimethachlor, metolachlor, pretilachlor, 2-chloro-n-(1-methyl-2-methoxyethyl)-acet-2,6-xylidide, imidocloprid, alachlor, butachlor, propachlor, dimethenamid, bifenox, 4-(4-pentyn-1-yloxy)diphenylether, acifluorfen, oxyfluorfen, fluoroglycofen-ethyl, fomesafen, cis,trans-(+)-2-ethyl-5-(4-phenoxyphenoxymethyl)-1,3-dioxolane, fluazifop-butyl, haloxyfop-methyl, haloxyfop-(2-ethoxyethyl), endosulfan, fluorotopic, fenoxapropethyl, quizalofop-ethyl, propaquizafop, diclofop-methyl, butralin, ethalfluralin, fluchloralin, isopropalin, pendimethalin, profluralin, trifluralin, aclalanines furalaxyl, metalaxyl, benzoylprop ethyl, flamprop methyl, difenoconazole, etaconazole, propiconazole, 1,2-(2,4-dichlorophenyl)-pent-1-yl-1h-1,2,4-triazole, triadimefon, dioxacarb, furathiocarb, aldicarb, benomyl, 2-sec-butylphenylmethylcarbamate, etiofencarb, fenoxycarb, isoprocarb, propoxur, carbetamid, butylate, di-allat, eptc, molinate, thiobencarb, tri-allate, vemolate, piperophos, anilofos, butamifos, azamethiphos, chlorfenvinphos, dichlorvos, diazinon, methidathion, azinphos ethyl, azinphos methyl, chlorpyrifos, chlorthiofos, crotoxyphos, cyanophos, demeton, dialifos, dimethoate, disulfoton, etrimfos, famphur, flusulfothion, fluthion, fonofos, formothion, heptenophos, isofenphos, isoxathion, malathion, mephospholan, mevinphos, naled, oxydemeton methyl, oxydeprofos, parathion, phoxim, pyrimiphos methyl, profenofos, propaphos, propetamphos, prothiophos, quinalphos, sulprofos, phemephos, terbufos, triazophos, trichloronate, fenamipos, isazophos, s-benzyl-o,o-diisopropylphosphorothioate, edinphos, pyrazophos and combinations thereof.

According to some embodiments, the additional agent is added at a concentration below a minimum recommended concentration. As used herein, the term “minimum recommended concentration” refers to the minimum concentration of an agent needed to obtain its insect repellant, insecticidal, pesticidal, fungicidal, fungistatic, bactericidal, bacteriostatic and/or spoilage retardant effect, when used as a sole agent.

According to some embodiments, the essential oil may be co-encapsulated with an insect growth regulator (IGR). Additionally or alternatively, the IGR may be separately encapsulated or non-encapsulated. It is thus understood that the non-woven fabric disclosed herein may have associated therewith microencapsulated volatile essential oils and IGRs the latter being co-encapsulated with the volatile essential oil, separately encapsulated or non-encapsulated. Each possibility is a separate embodiment. According to some embodiments, the essential oil and the IGR may be encapsulated directly on the fabric, thereby forming an encapsulating envelope around the essential oil, the IGR and the fabric.

Non-limiting examples of suitable IGRs include: azadirachtin, novaluron, hydroprene, methoprene, pyriproxyphen, triflumuron and combinations thereof. Each possibility is a separate embodiment.

According to some embodiments, there is provided a method for producing a material for preservation of crops including post-harvest crops. According to some embodiments, the material comprises a non-woven fabric in non-covalent association with an encapsulated essential oil, the essential oil having activity selected from insect-repellant, fungicidal, fungistatic, bactericidal, bacteriostatic and/or spoilage retardant effect or any combination thereof. Each possibility is a separate embodiment.

According to some embodiments, the encapsulated essential oil is microencapsulated.

According to some embodiments, the encapsulation may be formed by a polymerization process performed on the fabric. For example, the non-woven fabric may be immersed in an essential oil, which contains monomers prior to catalyzing a polymerization reaction. According to some embodiments, microencapsulation of the essential oil (and optionally additional components) may be done separately whereafter the microcapsules are adhered to the fabric by immersion of the fabric in a solution containing the pre-formed microcapsules or by spraying a solution or powder comprising the microcapsules on the fabric. Each possibility is a separate embodiment.

It is understood that the microcapsule and/or the encapsulation may be formed (whether directly on the fabric or separately) using any suitable polymerization reaction. Non-limiting examples of suitable processes for forming encapsulated essential oils are disclosed herein below.

According to some embodiment, the microcapsule may be prepared by dissolving a di- or polyisocyanate into an essential oil, emulsifying the resulting mixture in an aqueous solution containing a di- or polyamine, and or a di or polyhydroxy compound to effect encapsulation of the essential oil through interfacial polymerization. This process results in the formation of microcapsules having a polyurea and/or polyurethane film around the essential oil.

According to some embodiment, the microcapsule may be prepared by: (a) admixing at least one alkanoic acid with a water-immiscible liquid, wherein said water-immiscible liquid comprises at least one essential oil, thereby obtaining a water-immiscible mixture; (b) admixing the water-immiscible mixture of step (a) with an aqueous basic solution to obtain a suspension; and (c) admixing into the suspension of step (b) an aqueous salt solution comprising at least one multivalent cation, thereby obtaining microcapsules having an outer encapsulating amphiphatic shell, the outer amphiphatic shell consisting essentially of a multivalent salt form of the at least one alkanoic acid.

According to some embodiment, the microcapsule may be prepared by (a) mixing at least one polymer, into at least one essential oil or derivatives thereof, wherein the polymer is selected from the group consisting of a polyethylene glycol (PEG), polypropylene glycol (PPG), polyethylene oxide (PEO), polypropylene oxide (PPO), polyvinylpyrrolidone (PVP), and homo- and co-polymers thereof, to obtain a first mixture; (b) mixing at least one polyacid with an aqueous solution, wherein the at least one polyacid is selected from the group consisting of: agaropectin, alginate, alginic acid, carboxymethyl cellulose, chondroitin sulfate, heparin, polyacrylic acid and its copolymers, pectin, polygalacturonic acid, starch carboxylic acid, xanthan gum, and combinations and/or derivatives thereof; to obtain a second mixture; (c) combining the first and second mixtures, thereby obtaining a suspension of microcapsules, each microcapsule comprising a core comprising an essential oil or a derivatives thereof and a shell encapsulating the core, the shell comprising an interpolymeric complex of the at least one polyacid and the at least one polymer; and (d) adding an aqueous solution comprising at least one multivalent cationic moiety to the suspension obtained in step (c); thereby crosslinking the interpolymeric complex with the at least one multivalent cationic moiety.

According to some embodiments, there is provided method for preservation of a crop, the method comprising exposing the crop to a material comprising a non-woven fabric; and an encapsulated essential oil embedded in the non-woven fabric, as essentially described herein.

According to some embodiments, the fabric may have an insect-repellant, insecticidal, fungicidal, fungistatic, nematicidal, herbicidal, bactericidal, bacteriostatic and/or spoilage retarding property or any combination of properties. Each possibility is a separate embodiment.

As used herein the term “exposing” may refer to placing the fabric on the crop, in proximity to the crop or within containers containing the crop.

According to some embodiments, the essential oil is selected from the group consisting of angelica oil, anise oil, basil oil, bay oil, bergamot oil, bois de rose oil, calendula oil, camphor oil, cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill oil, eucalyptus oil, fennel oil, garlic oil, geranium oil, ginger oil, grapefruit oil, guaiacwood oil, hiba oil, iris oil, Japanese mint oil, jasmine oil, lavender oil, laurel leaf oil, lemon oil, lemongrass oil, lime oil, linaloe oil, lindera oil, mandarin oil, lemongrass oil, mustard oil, neroli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, meric oil, vetivert oil, western mint oil, white micromeria oil, wintergreen oil. Each possibility is separate embodiment.

According to some embodiments, the essential oil is oregano oil. According to some embodiments, the essential oil is mustard oil. According to some embodiments, the essential oil is tea tree oil.

According to some embodiments, the methods extends the shelf life of the crop by at least 10%, 20% 30%, 40% 50%, 60% or 70%, 100%, 200%, 300% or more. Each possibility is separate embodiment.

According to some embodiments, the crop is edible. The crop is selected from the group consisting of grapes, lettuce, peppers, cherries, strawberries, onions, herbs, apples, pears, melons, avocado, citrus fruit etc.

According to some embodiments, the crop is pre-harvest crop. According to some embodiments, the crop is post-harvest crop. According to some embodiments, the method is further suitable for the treatment of soil, fields, bushes, trees and the like, for example by spreading the fabric over the desired area.

According to some embodiments, the concentration of the encapsulated essential oil within the fabric is in the range of 0.01-10 gr of encapsulated essential oil/m², 0.01-50 gr of encapsulated essential oil/m², 0.05-10 gr of encapsulated essential oil/m², 0.05-10 gr of encapsulated essential oil/m², 0.1-40 gr of encapsulated essential oil/m², 0.25-30 gr of encapsulated essential oil/m²; in the range of 0.5-25 gr of encapsulated essential oil/m² in the range of 1-20 gr of encapsulated essential oil/m², in the range of 1-10 gr of encapsulated essential oil/m², in the range of 0.1-10 gr of encapsulated essential oil/m², in the range of 0.1-1 gr of encapsulated essential oil/m² or any other suitable range within the range of 0.01-50 gr of encapsulated essential oil/m². Each possibility is a separate embodiment. It is understood that the concentration of the essential oil within the fabric can be determined by various methods. For example, the essential oil may be extracted from the fabric by placing the fabric in methanol and ultrasonicating to rupture the microcapsules adhered to the fabric and releasing the essential oil into the methanol. Essential oil content can then be determining using conventional HPLC methods.

According to some embodiments, the non-woven fabric associated with the encapsulated essential oil exerts an insect-repellant, a fungicidal, a fungistatic, a bactericidal, a bacteriostatic and/or a spoilage retardant effect on the crops. Each possibility is a separate embodiment. According to some embodiments, the insect-repellant, the fungicidal, the fungistatic, the bactericidal, the bacteriostatic and/or the spoilage retardant effect of the encapsulated essential oil containing non-woven fabric lasts for at least 1 week at least two weeks, at least one month, at least two months, at least 6 months, or at least 1 year after association of the encapsulated essential oil to the non-woven fabric and/or after opening and/or unsealing a package containing the fabric. Each possibility is a separate embodiment.

According to some embodiments, the insect-repellant, the insecticidal, the fungicidal, the fungistatic, the nematicidal, the herbicidal, the bactericidal, the bacteriostatic and/or the spoilage retardant effect of the encapsulated essential oil containing non-woven fabric lasts for at least 1 week at least two weeks, at least one month, at least two months, at least 6 months or at least 1 year after association of the encapsulated essential oil to the non-woven fabric and/or after opening a package containing the fabric. Each possibility is a separate embodiment.

According to some embodiments, the method comprise exposing the crop to the fabric when stored or grown in a temperature in the range of 10° C.-45° C., 15° C.-35° C., 20° C.-30° C. or any other suitable temperature above 4° C. and/or below 50° C., such as any range within 10° C.-45° C. Each possibility is a separate embodiment.

According to some specific embodiments, there is provided a microcapsule for inhibiting browning of a crop, the microcapsule comprising a core containing mustard oil and a shell encapsulating the core; wherein the mustard oil, upon release, exerts an anti-browning effect on the crop. According to some embodiments, there is provided a microcapsule for inhibiting browning of a crop, the microcapsule comprising a core containing allyl isothiocyanate and a shell encapsulating the core; wherein the allyl isothiocyanate, upon release, exerts an anti-browning effect on the crop. According to some embodiments, the allyl isothiocyanate is of natural origin. For example, it may be derived from black mustard (Brassica nigra) or brown Indian mustard (Brassica juncea). According to some embodiments, the allyl isothiocyanate is synthetic.

As used herein the terms, “browning” and “enzymatic browning” may be used interchangeably. Without being bound by any theory, the terms refer to a chemical process, involving polyphenol oxidase, catechol oxidase, or other enzymes that create melanins and benzoquinones from natural phenols, resulting in a brown color. In general, enzymatic browning requires exposure to oxygen, for example the browning that occurs when an apple is cut.

According to some embodiments, the crop may be a crop including and/or containing polyphenol oxidase. Non-limiting examples of crops, the browning of which can be inhibited by the microcapsules containing allyl isothiocyanate and/or mustard oil include: lettuce, apples, pears, bananas, olives, avocado, potatoes and any combination thereof. Each possibility is a separate embodiment.

According to some embodiments, the shell of the microcapsule may be a polyurea and/or a polyurethane film, essentially as described herein or as previously disclosed in WO 2004/098767. Additionally or alternatively, the shell may be an amphipathic shell comprising a multivalent salt form of an alkanoic acid. However, it is understood to one of ordinary skill in the art that any other shell, such as but not limited to any polymeric shell, suitable for encapsulation of the allyl isothiocyanate and/or the mustard oil may also be used and is within the scope of the present disclosure.

According to some embodiments, the microcapsule contains 10%-90% w/w, 10%-75% w/w, 10%-60% w/w, 10%-50% w/w, 20-80% w/w or any other suitable range within the range of 10%-95% w/w of the allyl isothiocyanate and/or the mustard oil. Each possibility is a separate embodiment.

According to some embodiments, there is provided a composite material for inhibiting browning of crops, the material comprising a non-woven fabric in non-covalent association with encapsulated allyl isothiocyanate and/or mustard oil having an anti-browning effect; wherein the concentration of the encapsulated allyl isothiocyanate and/or the encapsulated mustard oil within the fabric is in the range of 0.1 gr/m² to 20 gr/m² of fabric. According to some embodiments, the concentration of the encapsulated allyl isothiocyanate and/or the encapsulated mustard oil within the fabric is in the range of 1 gr/m² to 10 gr/m² of fabric. According to some embodiments, the concentration of the encapsulated allyl isothiocyanate and/or the encapsulated mustard oil within the fabric is in the range of 3 gr/m² to 10 gr/m² of fabric.

According to some embodiments, the release rate of the allyl isothiocyanate and/or the mustard oil from the fabric is in the range of 0.1-0.5 gr, 0.1-0.2 gr or 0.01-0.5 gr per day per m² of fabric. Each possibility is a separate embodiment.

According to some embodiments, the non-woven fabric may be any non-woven fabric as disclosed herein. According to some embodiments, the microcapsules may be associated to the fabric using any of the techniques disclosed herein.

According to some embodiments, the fabric may be contained within a package or sealed envelope preventing evaporation of the mustard oil prior to opening thereof. According to some embodiments, the fabric may be vacuum packed prior to use, essentially as described herein

According to some embodiments, there is provided a method for inhibiting browning of crops, the method comprising exposing the crops to a composition comprising microencapsulated allyl isothiocyanate and/or mustard oil, thereby inhibiting the enzymatic browning of the crops.

According to some embodiments, the composition may be an aqueous formulation containing the microcapsules. According to some embodiments, the composition may be a powder. According to some embodiments, the composition may be a fabric, such as but not limited to a non-woven fabric, containing and/or incorporated therein, the microcapsules.

According to some embodiments, the crops may be crops including and/or containing polyphenol oxidase. Non-limiting examples of crops, the browning of which can be inhibited by the microcapsules containing the allyl isothiocyanate and/or the mustard oil, include lettuce, apples, pears, bananas, olives, avocado, potatoes and any combination thereof. Each possibility is a separate embodiment. According to some embodiments, the crops is lettuce.

According to some embodiments, exposing crops to a non-woven fabric associated with the microencapsulated allyl isothiocyanate and/or mustard oil comprises storing the crops in containers containing therein the non-woven fabric.

According to some embodiments, exposing crops to a non-woven fabric associated with the microencapsulated allyl isothiocyanate and/or mustard oil extends the shelf life of the crops by at least 10%, 20% 30%, 40% 50%, 60% or 70%, 100%, 200%, 300% or more. Each possibility is separate embodiment.

According to some embodiments, there is provided a material for preservation of a crops, the material comprising a non-woven fabric in non-covalent association with an encapsulated essential oil, the essential oil having activity selected from insect-repellant, fungicidal, fungistatic, bactericidal, bacteriostatic and/or spoilage retardant effect; the encapsulated essential oil embedded in or adhering to the non-woven fabric; wherein the concentration of the encapsulated essential oil within the fabric is in the range of 0.1 gr of encapsulated essential oil/m² to 10 gr or in the range of of encapsulated essential oil/m² of fabric or in the range of 0.05 gr of encapsulated essential oil/m² to 1 gr or in the range of of encapsulated essential oil/m² of fabric; or wherein the material exerts an insect-repellant, a fungicidal, a fungistatic, a bactericidal, a bacteriostatic and/or a spoilage retardant effect on the crops; and/or wherein the material has a water content of less than 10 weight percent, of less than 5 weight percent or of less than 3 weight percent; and/or wherein the microcapsule comprises a polyurea, a polyurethane or an amphiphatic shell; and/or wherein the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill oil, eucalyptus oil, fennel oil, garlic oil, geranium oil, ginger oil, grapefruit oil, guaiacwood oil, hiba oil, camphor oil, iris oil, Japanese mint oil, jasmine oil, lavender oil, laurel leaf oil, lemon oil, lemongrass oil, lime oil, linaloe oil, lindera oil, mandarin oil, mustard oil, neroli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, meric oil, vetivert oil, western mint oil, white micromeria oil, wintergreen oil, combinations and/or derivatives thereof; and/or wherein the derivative is selected from the group consisting of allyl isothiocyanate, alpha-terpineol, amyl cinnamic aldehyde, anisic aldehyde, benzyl alcohol, benzyl acetate, cinnamaldehyde, cinnamic alcohol, carvacrol, carveol, carvone, citral, citronellal, citronellol, eucalyptol (cineole), eugenol, iso-eugenol, galaxolide, geraniol, guaiacol, hexanal, ionone, d-limonene, menthol, methyl anthranilate, methyl ionone, methyl salicylate, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin, and any combination thereof; and/or wherein the material further comprises a non-volatile oil; preferably wherein the non-volatile oil is selected from the group consisting of: cottonseed oil, neem oil, castor oil, pyrethrum oil, sesame oil, combinations and/or derivatives thereof; and/or wherein the material further comprises a natural preservative; and/or wherein the material is devoid of synthetic preservatives; and/or wherein the material is devoid of binders; and/or wherein the material is devoid of surfactants; and/or wherein the material is devoid of synthetic active ingredients and/or wherein the material further comprises an outer coating layer; preferably wherein the outer coating layer is a wax.

The following examples are presented in order to more fully illustrate some embodiments of the invention. They should, in no way be construed, however, as limiting the broad scope of the invention.

### EXAMPLES

### Example 1—Method for Preparing Polyurethane Microencapsulated Essential Oil

17.5 g TDI (toluene di-isocyanate) was mixed into 125 g citronella oil, which was added into 250 g water containing 2.5 g PVA using a high shear mixer. 27.8 g PEG 4000 dissolved in 70 ml of water was then added and mixing was continued for two hours at room temperature. To the dispersion of microcapsules was added 0.4 g xanthan gum (rhodopol), 2 g fungicide (nefocide) or 4 g Rosemary oil and 5 g SDS (sodium dodecyl sulfate, 1%).

Similar microcapsules were produced using tea tree oil, mustard oil and oregano oil, each instead of the citronella oil. It is further understood, that the citronella oil may be substituted with or co-encapsulated with any other essential oil, non-volatile oil and/or additional agent, as essentially described herein.

### Example 2—Method for Preparing Polyalkanoic Acid Microencapsulated Essential Oil

60 g stearic acid was dissolved in 125 g oregano oil. The solution was mixed with a 10% (w/w) NaOH solution for 10 min, after which a 10% (w/w) CaCl₂ solution was added and mixed. To this, a solution containing 520 mL water, 8 g rosemary oil, 40 g SDS and 20 g Tween 80 was added and mixed. While stirring, 1 g of guar gum and water to make a 1 liter solution was added to the mixture.

Similar microcapsules were produced using tea tree oil, citronella oil and mustard oil, each instead of oregano oil. It is further understood, that the oil may be substituted with or co-encapsulated with any other essential oil, non-volatile oil and/or additional agent, as essentially described herein.

### Example 3—Method of Preparing a Non-Woven Fabric Having Microencapsulated Essential Oil Associated Therewith by Spraying

1 m² non-woven fabrics was sprayed with 1000 mL of a suspension of microencapsulated essential oil (prepared according to one of the methods disclosed in examples 1 and 2). The fabrics were then centrifuged using a manual centrifuge for 3 minutes after which water is discarded and an additional centrifugation of 1 minute is performed. The fabrics were finally allowed to dry in air dried for 0.5-1 hours. It is understood that the amount of microencapsulated essential oil associated with the fabric can be adjusted by varying the concentration of microcapsules in the suspension and/or by controlling the volume of suspension sprayed. This enables determining a minimum concentration of microcapsules required to achieve a desired concentration of essential oil, associated with the fabric.

### Example 4—Method of Preparing a Non-Woven Fabric Having Microencapsulated Essential Oil Associated Therewith by Immersion

1 m² non-woven fabrics was immersed in a 1000 mL suspension of microencapsulated essential oil for approximately one minute, centrifuged using a manual centrifuge for 3 minutes after which water is discarded followed by an additional centrifugation of 1 minute. The fabrics were finally air dried for 0.5-1 hours. It is understood that the amount of microencapsulated essential oil embedded in the fabric can be adjusted by varying the concentration of microcapsules in the suspension, thereby enabling determination of a minimum concentration of microcapsules required to achieve a desired concentration of essential oil, associated with the fabric. It is further understood that not all of the microcapsule suspension needs to be adsorbed by the fabric.

### Example 5—Method of Preparing a Non-Woven Fabric Having Encapsulated Essential Oil Associated Therewith

17.5 g TDI (toluene di-isocyanate) was mixed into 125 g citronella oil using a high shear mixer. 0.5 m² non-woven fabric was immersed in the solution for 30 min, after which it was immersed in a solution of 27.8 g PEG 4000 dissolved in 70 ml of water with continuous shaking for 30 minutes at room temperature. The fabric was then washed in water and air-dried.

### Example 6—Determination of Essential Oil Concentration Associated with a Non-Woven Fabric

A piece measuring 1 cm² of fabric was weighed on an analytical balance (Wn).

The fabric was immersed in a 10 mL suspension containing microencapsulated essential oil for approximately 1 minute. The fabric was then air dried at room temperature for 1 hour and weighed again (Wc). The amount of microcapsules adhered to the fabric, Wmc, was calculated by subtracting the weight of the neat fabric, Wn from the weight of the coated fabric, Wc.

The fabric was then placed in 25 mL volume of Methanol and ultrasonicated for 60 minutes to rupture the capsules and release the essential oil into the methanol. The concentration of essential oil (grams per m² fabric), derived from microcapsules adhered to the non-woven fabric, was determined using standard HPLC and/or Gas Chromatography techniques. It was determined that the fabric can absorb up to 20 g of oil/m² of fabric.

### Example 7—Determination a Release Profile of the Essential Oil from the Non-Woven Fabric

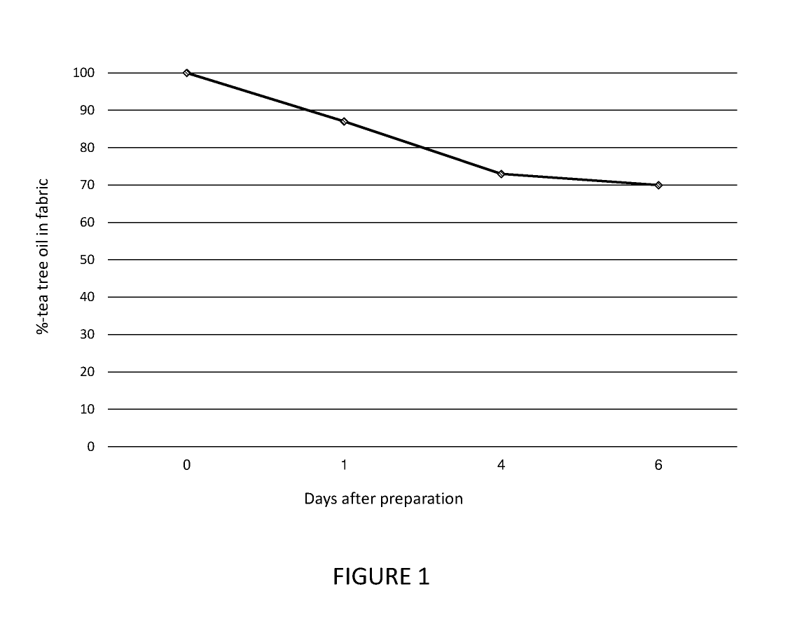

Fabric associated with tea tree oil was produced as essentially described in example 4 and subsequently stored unsealed at 6° C. The concentration of the tea tree in the fabric was determined on day of preparation (day 0, set as 100%) and then at 1, 2, 4 and 6 days after the association of the microcapsules with the fabric, according to the method described in Example 6. As seen from FIG. 1, approximately 70% of the tea tree oil remained associated with the fabric 6 days after it association therewith. Furthermore, the tea tree oil was released from the fabric constantly along the entire period.

### Example 8—Efficacy

### Example 8A—Prevention of Decay of Grapes

The efficacy of the microencapsulated essential oil containing non-woven fabric as an insect-repellant, a fungicidal, a fungistatic, a bactericidal, a bacteriostatic and/or a spoilage retardant agent, was determined by observing the decay of grapes. In short, an aqueous formulation of microencapsulated tea tree oil was prepared via interfacial polymerization, as essentially described in Example 1. The formulation contained 3% (w/w) tea tree oil. The microcapsules were associated with the fabric using the immersion technique essentially described in Example 4. In short, an aqueous dispersion was made by mixing 1 part of the aqueous formulation containing the microencapsulated tea tree oil with 19 parts of water (1:20 dilution). A polypropylene nonwoven fabric was then immersed in the aqueous dispersion for 60 seconds and the fabric dried by centrifugation. The amount of tea tree oil on the fabric was 0.15 g/per m² fabric.

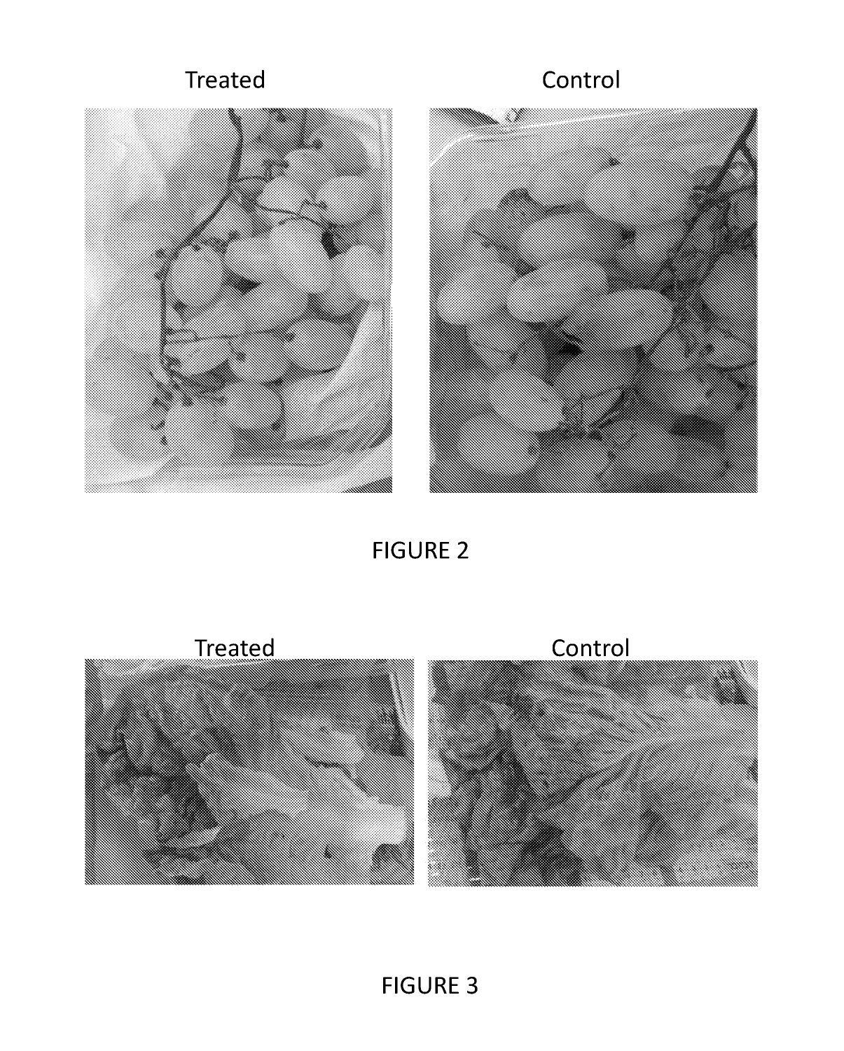

1 kg grapes were then stored for 1 week at room temperature in containers coated with a 0.25 m² of the fabric associated with microencapsulated tea tree oil or without fabric. As seen in FIG. 2, the grapes stored in containers coated with the microencapsulated tea tree oil containing fabric (left panel—treated) showed no sign of decay or infestation. This as opposed to grapes stored in the control containers (right panel—control), devoid the non-woven fabric, which showed significant decay, primarily due to fungal infestation.

### Example 8B—Inhibition of Lettuce Browning

The efficacy of the microencapsulated essential oil containing non-woven fabric as an insect-repellant, a fungicidal, a fungistatic, a bactericidal, a bacteriostatic and/or a spoilage retardant agent, was determined by observing browning of lettuce. In short, an aqueous formulation of microencapsulated mustard oil was prepared via interfacial polymerization, as essentially described in Example 1. The formulation contained 5% (w/w) of the mustard oil. The microcapsules were associated with the fabric using the immersion technique essentially described in Example 4. In short, an aqueous dispersion was made by mixing 1 part of the aqueous formulation containing the microencapsulated mustard oil with 19 parts of water (1:20 dilution). A polypropylene nonwoven fabric was then immersed in the aqueous dispersion for 60 seconds and the fabric dried by centrifugation. The amount of mustard oil on the fabric was 150 mg/per m² fabric

Leaves of Lettuce (100 g) were washed with water and dried. The dry leaves were then placed in a closed plastic container to which a piece of coated fabric (375 cm²) was added. As a control, leaves were also placed in a container devoid of a coated fabric. The lettuce leaves were monitored for enzymatic browning for a period of 2 weeks.

As seen in FIG. 3, lettuce stored in containers with the microencapsulated mustard oil containing fabric (left panel—treated) showed no signs of browning. This as opposed to lettuce stored in the control containers (right panel—control), devoid the non-woven fabric, which showed significant browning of the lettuce.

These result, show the advantageous effect of microencapsulated mustard oil containing fabrics in the prevention of enzymatic browning in lettuce.

### Example 8C—Inhibition of Molds on Stems and Rotting of Peppers

The efficacy of the microencapsulated essential oil containing non-woven fabric as an insect-repellant, a fungicidal, a fungistatic, a bactericidal, a bacteriostatic and/or a spoilage retardant agent, was determined by observing molds on the stem of peppers and pepper rotting.

The microcapsules were encapsulated as described above. In short, an aqueous formulation of microencapsulated oregano oil was initially prepared via interfacial polymerization, as essentially described in Example 1. The formulation contained 3% (w/w) of the oregano oil. The microcapsules were then associated with the fabric using the immersion technique essentially described in Example 4. In short, an aqueous dispersion was made by mixing 1 part of the aqueous formulation containing the microencapsulated oregano oil with 19 parts of water (1:20 dilution). A polypropylene nonwoven fabric was then immersed in the aqueous dispersion for 30 seconds and the fabric dried by centrifugation. The amount of oregano oil on the fabric was 8 mg/per 620 cm²/fabric.

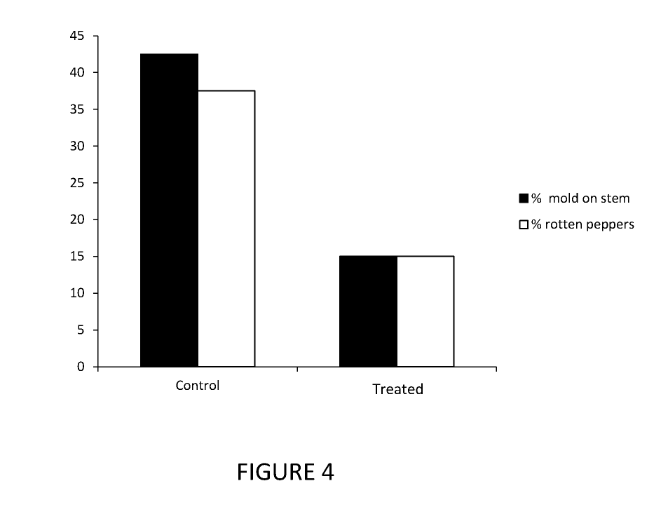

Subsequently, 2 kg of bell peppers were stored in plastic bags for 20 days at 20° C., with and without a microencapsulated oregano oil containing fabric. The amount of oregano oil on the fabric was 8 mg. The peppers were evaluated for 20 days for molds on their stems and for rotting. As seen from FIG. 4, the percentage of peppers having molds on their stems as well as the percentage of rotten peppers decreased significantly when the peppers were stored in containers including microencapsulated oregano oil containing fabric (treated) as compared to peppers stored in control containers devoid of fabric (control). Empty fabric having no microencapsulated essential oil showed no effect. Furthermore, it was surprisingly found that low concentrations of oregano oil (approximately 0.1-0.2 g/m²) provided optimal protection, whereas significantly higher concentrations were found to be phytotoxic.

### Example 9—Determination of a Minimum Concentration of Essential Oils

Pieces of 10 cm² non-woven fabric are immersed in suspensions of microcapsules, each piece in a suspension with a gradually reduced concentration of microcapsules (three pieces of fabric for each concentration). The concentration of essential oil adhered to the fabric is determined as described in example 5. The efficacy of the microcapsule containing fabric as an insect-repellant, a fungicidal, a fungistatic, a bactericidal, a bacteriostatic and/or spoilage retardant agent, is determined for each concentration of essential oil by observing the decay of grapes stored for 1-2 weeks at room temperature in containers as described in example 8. Each container is coated with a fabric containing a different concentration of essential oil, and compared to storage in control containers coated with fabric devoid essential oils as well as to fabrics containing non-encapsulated essential oils and containers, which are not coated with fabric. The minimum amount of essential oil required to achieve a desired efficacy can thus be determined.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising”, when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1. A composite material for preservation of a crop, the material comprising:
a non-woven fabric in non-covalent association with a microencapsulated essential oil, the essential oil having activity selected from insect-repellant, fungicidal, fungistatic, bactericidal, bacteriostatic and/or spoilage retardant effect;
the microencapsulated essential oil embedded in or adhering to the non-woven fabric;
wherein the water content of the composite material is less than 10%; and
wherein said composite material exerts an insect-repellant, a fungicidal, fungistatic, a bactericidal, a bacteriostatic and/or a spoilage retardant effect on the crop.

2. The composite material of claim 1, exerting the insect-repellant, the fungicidal, fungistatic, the bactericidal, the bacteriostatic and/or the spoilage retardant effect for at least one month after association of said microencapsulated essential oil to said non-woven fabric.

3. (canceled)

4. The composite material of claim 1, wherein the concentration of the microencapsulated essential oil within the fabric is in the range of 0.01 gr of essential oil/m² to 10 gr of essential/m² of fabric.

5. The material of claim 1, wherein the concentration of the microencapsulated essential oil within the fabric is in the range of 0.05 gr of essential oil/m² to 1 gr of essential/m² of fabric.

6. The material of claim 1 having a water content of less than 3 weight percent.

7. The material of claim 1, wherein said microcapsule is associated with said non-woven fabric by immersion of said non-woven fabric within a solution comprising said microencapsulated essential oil.

8. The material of claim 1, wherein said microcapsule comprises a polyurea, a polyurethane or an amphiphatic shell.

9. The material of claim 1, wherein the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill oil, eucalyptus oil, fennel oil, garlic oil, geranium oil, ginger oil, grapefruit oil, guaiacwood oil, hiba oil, camphor oil, iris oil, Japanese mint oil, jasmine oil, lavender oil, laurel leaf oil, lemon oil, lemongrass oil, lime oil, linaloe oil, lindera oil, mandarin oil, mustard oil, neroli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, meric oil, vetivert oil, western mint oil, white micromeria oil, wintergreen oil, combinations and/or derivatives thereof.

10. The material of claim 9, wherein the derivative is selected from the group consisting of allyl isothiocyanate, alpha-terpineol, amyl cinnamic aldehyde, anisic aldehyde, benzyl alcohol, benzyl acetate, cinnamaldehyde, cinnamic alcohol, carvacrol, carveol, carvone, citral, citronellal, citronellol, eucalyptol (cineole), eugenol, iso-eugenol, galaxolide, geraniol, guaiacol, hexanal, ionone, d-limonene, menthol, methyl anthranilate, methyl ionone, methyl salicylate, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-01, terpinyl acetate, 4-tert butylcyclohexyl acetate, thymol, trans-anethole, vanillin, ethyl vanillin, and any combination thereof.

11. (canceled)

12. The material of claim 1, wherein the non-volatile oil is selected from the group consisting of: cottonseed oil, neem oil, castor oil, pyrethrum oil, sesame oil, combinations and/or derivatives thereof.

13. The material of claim 1, further comprising a natural preservative.

14. The material of claim 1, being devoid of synthetic preservatives.

15. The material of claim 1, being devoid of binders.

16. The material of claim 1, further comprising an outer coating layer.

17. The material of claim 16, wherein the outer coating layer is a wax, or a polymer.

18. (canceled)

19. A composite material for inhibiting browning of a crop, the material comprising
a non-woven fabric in non-covalent association with microencapsulated mustard oil, the mustard oil having an anti-browning effect on the crop; and
wherein the water content of the composite material is less than 10%.

20. The composite material of claim 19, wherein the concentration of the microencapsulated mustard oil within the fabric is in the range of 0.05 gr of mustard oil/m² to 10 gr of mustard oil/m² of fabric.

21. (canceled)

22. A method for inhibiting browning of a crop, the method comprising exposing the crop to a non-woven fabric associated with microencapsulated mustard oil, thereby inhibiting the enzymatic browning of the crop.

23. The method of claim 22, wherein the crop is susceptible to browning due to presence of polyphenol oxidase.

24. The method of claim 22, wherein the crop comprises lettuce.

25. (canceled)
